(19) United States
(12) Patent Application Publication
(10) Pub. No.: US 2019/0191768 A1
(43) Pub. Date: Jun. 27, 2019

(54) AUTOMATIC MANUAL BATTERY ASSEMBLY AND ELECTRONIC CIGARETTE THEREOF

(71) Applicant: CHANGZHOU JWEI INTELLIGENT TECHNOLOGY CO., LTD., Changzhou (CN)

(72) Inventor: Weihua QIU, Changzhou (CN)

(21) Appl. No.: 16/286,342

(22) Filed: Feb. 26, 2019

Related U.S. Application Data
(63) Continuation-in-part of application No. PCT/CN2017/099163, filed on Aug. 25, 2017.

(30) Foreign Application Priority Data
Aug. 29, 2016 (CN) 201620977174.8

(51) Int. Cl. A24F 47/00; A24F 7/00; H01M 10/42

(52) U.S. Cl. CPC A24F 47/008; H01M 2220/30; H01M 10/425; A24F 7/00

(57) ABSTRACT

An automatic manual electronic cigarette includes an atomizing assembly, a battery configured to supply electrical energy to the atomizing device, a control board, a sensor, a switch key and a shift key. The sensor is signally connected to the control board, the sensor controls closing or opening of the circuit between the battery and the atomizing assembly by sensing a specific parameter. The shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.

### CROSS-REFERENCE TO RELATED APPLICATIONS

This application is a continuation in part of International Patent Application No. PCT/CN2017/099163, filed on Aug. 25, 2017, entitled “automatic manual electronic cigarette”, which claims priority to Chinese Patent Application No. 201620977174.8, filed on Aug. 29, 2016. All of the aforementioned patent applications are hereby incorporated by reference in their entireties.

### FIELD

The present disclosure relates to the technical field of electronic cigarette, in particular to an automatic manual battery assembly and electronic cigarette thereof.

### BACKGROUND

The electronic cigarette is an electronic product that imitates cigarettes. The atomizing assembly of the electronic cigarette heats the smoke liquid in the cartridge to generate smoke, which can be sucked into by the user from the cigarette holder, thereby achieving the purpose of simulating smoking.

### SUMMARY

The present disclosure provides an automatic manual battery assembly and electronic cigarette thereof

An automatic manual electronic cigarette includes an atomizing assembly, a battery configured to supply electrical energy to the atomizing device, a control board, a sensor, a switch key and a shift key. The sensor is signally connected to the control board, the sensor controls closing or opening of the circuit between the battery and the atomizing assembly by sensing a specific parameter. The shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.

In one embodiment, the sensor is a pressure sensor.

In one embodiment, the automatic manual electronic cigarette further includes an air flow passage and a mouthpiece, the air flow passage is in communication with the mouthpiece, the sensor is configured for detecting the changes in pressure within the air flow passage.

In one embodiment, air passage of the sensor is in communication with the air flow passage.

In one embodiment, the shift key includes a plugging member and a locking member, when the shift key is displaced to the second position, the plugging member is disengaged or partially disengaged from the air flow passage, the locking member is latching the switch key, the control function of the sensor is triggered; when the shift key is displaced to the first position, the plugging member blocks the air flow passage, the locking member is separated from the switch key, the control function of the switch key is triggered.

In one embodiment, the automatic manual electronic cigarette further includes a housing and a bottom cover; the atomizing assembly, the control board and the battery are received in the housing.

In one embodiment, the switch key is disposed on the control board, the switch key is constrained between the control board and the housing.

In one embodiment, the shift key includes a base and a pushing member, the plugging member is disposed at the upper end of the base, the locking member is disposed at the lower end of the base, the base is located in the housing, an opening is defined in the housing at a position corresponding to the shift key, the pushing member protrudes outside through the opening of the housing.

In one embodiment, the housing and the bottom cover are connected by an interference fit.

In one embodiment, the automatic manual electronic cigarette further includes a connecting member, the connecting member is located at the upper end of the housing, the mouthpiece is connected to the connecting member, the air flow passage is defined in the connecting member.

A automatic manual battery assembly for an electronic cigarette, the electronic cigarette includes an atomizing assembly, the battery assembly includes a battery configured to supply electrical energy to the atomizing device, a control board, a sensor, a switch key and a shift key; the sensor is signally connected to the control board, the sensor controls closing or opening of the circuit between the battery and the atomizing assembly by sensing a specific parameter; the shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.

In one embodiment, the switch key is directly disposed on the circuit of the atomizing assembly and the battery.

In one embodiment, further includes an air flow passage, the air flow passage is in communication with the mouthpiece, the sensor is configured for sensing a change in pressure within the air flow passage.

In one embodiment, the sensor is a pressure sensor, an air passage of the sensor is in communication with the air flow passage, the sensor senses a pressure change in the air flow passage.

In one embodiment, the shift key includes a plugging member and a locking member, when the shift key is displaced to the second position, the plugging member is disengaged or partially disengaged from the air flow passage, the locking member is latching the switch key, the control function of the sensor is triggered; when the shift key is displaced to the first position, the plugging member blocks the air flow passage, the locking member is separated from the switch key, the control function of the switch key is triggered.

In one embodiment, the automatic manual electronic cigarette further includes a housing and a bottom cover; the atomizing assembly, the control board and the battery are received in the housing.

In one embodiment, the switch key is disposed on the control board, the switch key is constrained between the control board and the housing.

In one embodiment, the shift key includes a base and a pushing member, the plugging member is disposed at the upper end of the base, the locking member is disposed at the lower end of the base, the base is located in the housing, an opening is defined in the housing at a position corresponding to the shift key, the pushing member protrudes outside through the opening of the housing.

In one embodiment, the automatic manual electronic cigarette further includes a connecting member, the connecting member is located at the upper end of the housing, the mouthpiece is connected to the connecting member, the air flow passage is defined in the connecting member.

An electronic cigarette includes any one of the above t battery assemblies

The beneficial effects of the device are:

In the disclosure, the battery of the battery assembly powers the atomizing assembly. The sensor is electrically connected to the control circuit of the control board to automatically control the opening and closing of the circuit between the battery and the atomizing assembly, the switch key is configured to manually control the opening and closing of the circuit between the battery and the atomizing assembly. The shift key is provided with at least a first position and a second position that are displaceable. When the shift key is displaced to the first position, the sensor is prevented from sensing the specific parameter, the opening key can be mechanically displaced and controlled to control the opening and closing of the circuit between the battery and the atomizing assembly. When the shift key is displaced to the second position, the switch key can be made mechanically displaceable, the sensor can sense the specific parameter and control the opening and closing of the circuit between the atomizing assembly through the control board. The electronic cigarette of the present disclosure uses the shift key to alternately switch the applicable control mode of the electronic cigarette, that is, alternately to switch between manual cigarette lighting and automatic cigarette lighting. Additionally, the switch button uses a mechanical switching method instead of a circuit control or software controlled switching method. Thus, the electronic cigarette of the disclosure realizes the switching between manual cigarette lighting and automatic cigarette lighting.

### BRIEF DESCRIPTION OF THE DRAWINGS

FIG. 1 is a cross-sectional view of an automatic manual electronic cigarette in an automatic mode according to an embodiment of the present disclosure.

FIG. 2 is a cross-sectional view of the automatic manual electronic cigarette in a manual mode according to an embodiment of the present disclosure.

The following table list various components and reference numerals thereof.

| | |
|---|---|
| Atomizing assembly 1 | Control board 2 |
| Battery 6 | Mouthpiece 8 |
| Locking step 41 | Pushing member 51 |
| Locking member 54 | Housing 71 |
| Sensor 3 | Air passage 31 |
| Switch key 4 | Plugging member 53 |
| Connecting member 9 | Air flow passage 91 |
| Base 52 | Bottom cover 72 |

### DETAILED DESCRIPTION OF PREFERRED EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

When a feature or element is herein referred to as being “on” another feature or element, it can be directly on the other feature or element or intervening features and/or elements may also be present.

Terminology used herein is for the purpose of describing particular embodiments only and is not intended to be limiting of the disclosure. As used herein, the term “and/or” includes any and all combinations of one or more of the associated listed items and may be abbreviated as “/”.

### The First Embodiment

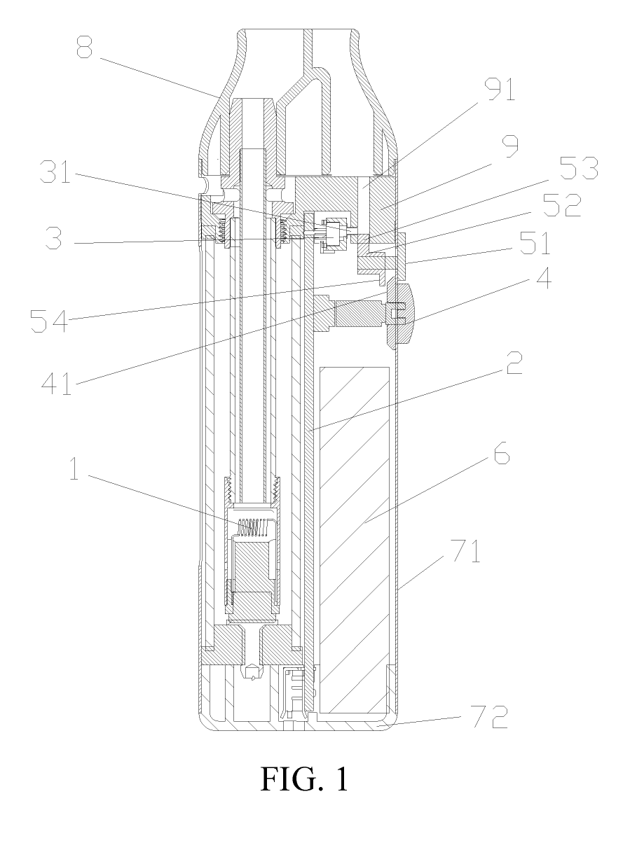

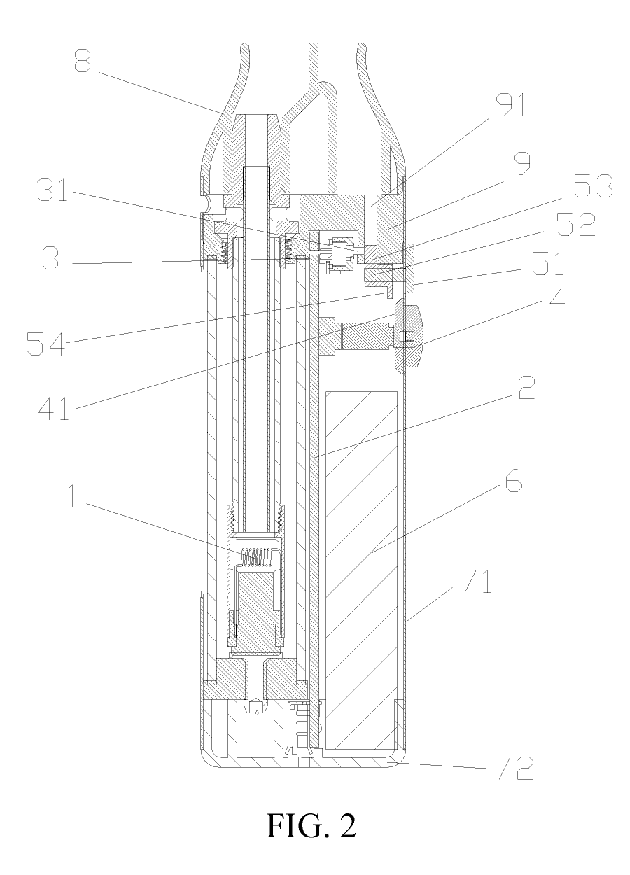

Referring to FIGS. 1-2, the automatic manual electronic cigarette provided by the present disclosure includes an atomizing assembly 1, a mouthpiece 8 and a battery assembly (not shown). The atomizing assembly 1 is connected to the battery assembly, and the battery assembly supplies electrical energy to the atomizing assembly 1. The battery assembly includes a battery 6, a sensor 3, a control board 2, a switch key 4 and a shift key. The sensor 3 is signally connected to the control board 2, and the sensor 3 controls closing or opening of the circuit between the battery 6 and the atomizing assembly 1 by sensing a specific parameter. The switch key 4 controls closing or opening of the circuit between the battery 6 and the atomizing assembly 1 by mechanical displacement. The shift key can be displaced to the first position and the second position. When the shift key is displaced to the first position, the sensor 3 cannot sense the specific parameter, the switch key 4 can be mechanically displaced and control closing or opening of the circuit between the battery 6 and the atomizing assembly 1. When the shift key is displaced to the second position, the switch key 4 cannot be mechanically displaced, the sensor 3 can sense the specific parameter.

The switch key 4 is signally connected to the control board 2, the switch key 4 controls the circuit between the battery 6 and the atomizing assembly 1 through a mechanical displacement. The sensor 3 is unable to sense the specific parameter when the switch key 4 is displaced to the first position, however, the switch key 4 can mechanically displace and control closing or opening of the circuit between the battery 6 and the atomizing assembly 1.

The sensor 3 is connected to the control board 2, and the switch key 4 is connected to the control board 2. The control board 2 includes a circuit electrically connecting the atomizing assembly 1 and the battery 6, and a control circuit for controlling closing or opening of the circuit between the atomizing assembly 1 and the battery 6. The control signal of the control circuit is provided by the sensor 3 or the switch key 4.

It can be understood that, in other embodiments, the switch key 4 is directly disposed on the circuit of the atomizing assembly 1 and the battery 6. That is, the switch key 4 does not indirectly control the on and off of the circuit between the battery 6 and the atomizing assembly 1 through a signal connection with the control board 2. The sensor 3 is connected to the control board 2, the control board 2 includes a circuit connecting the atomizing assembly 1 and the battery 6, and a control circuit that controls closing or opening of the circuit. The sensor 3 provides the control signal of the control circuit. The circuit that the switch key 4 connects the atomizing assembly 1 and the battery 6 and the circuit that the control board 2 connects the atomizing assembly 1 and the battery 6 is physically isolated.

It can be understood that, the sensor 3 can be any type of sensor, such as a pressure sensor, a temperature sensing sensor, a light sensing sensor, etc. In this embodiment, the sensor 3 is a pressure sensor. The detailed scheme adopted in this embodiment is disclosed below.

Specifically, the automatic manual electronic cigarette disclosed in this embodiment includes a housing 71. A bottom cover 72 is disposed at the bottom of the housing 71, the housing 71 and the bottom cover 72 are connected by an interference fit. The atomizing assembly 1, the control board 2, and the battery 6 are all located in the housing 71. The upper end of the housing 71 is provided with a connecting member 9, the mouthpiece 8 is connected to the connecting member 9. The connecting member 9 and the housing 71 are also connected by an interference fit, the mouthpiece 8 and the connecting member 9 are detachably and plugged together. Further, the control board 2 is disposed in the middle of the housing 71, the atomizing assembly 1 and the battery 6 are respectively disposed on two sides of the control board 2.

In one embodiment, the automatic manual electronic cigarette further includes an air flow passage 91, the air flow passage 91 is in communication with the mouthpiece 8. The sensor 3 is configured for sensing a change in pressure within the air flow passage 91. Specifically, the sensor 3 is disposed at an upper end of the control board 2 near the connecting member 9, the air flow passage 91 is defined on the connecting member 9. In order to ensure that the sensor 3 can sense the pressure change in the air flow passage 91, the air passage 31 of the sensor 3 is directly or indirectly connected to the air flow passage 91. Therefore, the air passage 31 can be inserted into the air flow passage 91, or an additional gas passage can be used to connect between the air passage 31 and the air flow passage 91. In the embodiment, the air passage 31 of the sensor 3 is in communication with the air flow passage 91.

The switch key 4 is disposed on the control board 2, the switch key 4 is disposed below the sensor 3 and is closer to the sensor 3. The switch key 4 is constrained between the control board 2 and the housing 71. That is, the switch key 4 includes a portion that is inside the housing 71 and another portion that is outside the housing 71. In use, the switching function is achieved by pressing the portion outside of the housing 71.

In this embodiment, the shift key is configured to switch the control functions of the sensor 3 and the switch key 4, the specific implementation manner is as follows: the shift key includes a plugging member 53 and a locking member 54, the shift key is displaceable to the first position and the second position. When the shift key is displaced to the second position, the plugging member 53 is disengaged or partially disengaged from the air flow passage 91, the locking member 54 is latching the switch key 4, the control function of the sensor 3 is triggered. When the switch key 4 is displaced to the first position, the plugging member 53 blocks the air flow passage 91, the locking member 54 is separated from the switch key 4, the control function of the switch key 4 is triggered. Specifically, the shift key includes a base 52 and a pushing member 51 connected the base 52. The plugging member 53 and the locking member 54 are disposed on two sides of the base 52, respectively. The base 52 is located in the housing 71, an opening is defined in the housing 71 at a position corresponding to the shift key, the pushing member 51 protrudes outside through the opening of the housing 71. The plugging member 53 projects from the lower end of the air flow passage 91 into the air flow passage 91, the locking member 54 is disposed toward the switch key 4. When the shift key is pushed up to the limit position, the plugging member 53 is further pushed into the air flow passage 91 and blocks the communication between the air passage 31 and the air flow passage 91, the locking member 54 and the switch key 4 are completely separated from each other, thereby, the control function of the switch key 4 is triggered, the control function of the sensor 3 is invalid. At this time, the shift key is located at the first position. When the shift key is pushed down to a limit position, the limit position is the second position. At this time, the locking member 54 is latched in a locking step 41 of the switch key 4, the plugging member 53 is partially removed from the air flow passage 91, the air passage 31 is restored to the state that in communication with the air flow passage 91, the switch key 4 cannot be pressed, that is, the function of the switch key 4 is disabled, the function of the sensor 3 is triggered. The automatic manual electronic cigarette of the embodiment realizes the switching between manual cigarette lighting and automatic cigarette lighting by the above method.

In the disclosure, the battery 6 of the battery assembly powers the atomizing assembly 1. The sensor 3 is electrically connected to the control circuit of the control board 2 to automatically control the opening and closing of the circuit between the battery 6 and the atomizing assembly 1, the switch key 4 is configured to manually control the opening and closing of the circuit between the battery 6 and the atomizing assembly 1. The shift key is provided with at least a first position and a second position that are displaceable. When the shift key is displaced to the first position, the sensor 3 is prevented from sensing the specific parameter, the switch key 4 can be mechanically displaced and controlled to control the opening and closing of the circuit between the battery 6 and the atomizing assembly 1. When the shift key is displaced to the second position, the switch key 4 can be made mechanically displaceable, the sensor 3 can sense the specific parameter and control the opening and closing of the circuit between the atomizing assembly 1 through the control board 2. The electronic cigarette of the present disclosure uses the shift key to alternately switch the applicable control mode of the electronic cigarette, that is, alternately to switch between manual cigarette lighting and automatic cigarette lighting. Additionally, the shift key uses a mechanical switching method instead of a circuit control or software controlled switching method. Therefore, the electronic cigarette of the present invention has both an automatic cigarette lighting function and a manual cigarette lighting function and can be freely switched.

The above-mentioned embodiments merely represent several implementations of the present application, and the descriptions thereof are more specific and detailed, but they shall not be understood as a limitation on the scope of the present application. It should be noted that, for those of ordinary skill in the art, variations and improvements may still be made without departing from the concept of the present application, and all of which shall fall into the protection scope of the present application. Therefore, the scope of protection of the present application shall be subject to the appended claims.

What is claimed is:

1. An automatic manual electronic cigarette, comprising:
an atomizing assembly;
a battery configured to supply electrical energy to the atomizing device;
a control board;
a sensor, the sensor is signally connected to the control board, the sensor controls closing or opening of the circuit between the battery and the atomizing assembly by sensing a specific parameter;
a switch key; and
a shift key, the shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.

2. The automatic manual electronic cigarette according to claim 1, wherein the sensor is a pressure sensor.

3. The automatic manual electronic cigarette according to claim 2, wherein the automatic manual electronic cigarette further comprises an air flow passage and a mouthpiece, the air flow passage is in communication with the mouthpiece, the sensor is configured for detecting the changes in pressure within the air flow passage.

4. The automatic manual electronic cigarette according to claim 3, wherein air passage of the sensor is in communication with the air flow passage.

5. The automatic manual electronic cigarette according to claim 4, wherein the shift key includes a plugging member and a locking member, when the shift key is displaced to the second position, the plugging member is disengaged or partially disengaged from the air flow passage, the locking member is latching the switch key, the control function of the sensor is triggered; when the shift key is displaced to the first position, the plugging member blocks the air flow passage, the locking member is separated from the switch key, the control function of the switch key is triggered.

6. The automatic manual electronic cigarette according to claim 5, wherein the automatic manual electronic cigarette further comprises a housing and a bottom cover; the atomizing assembly, the control board and the battery are received in the housing.

7. The automatic manual electronic cigarette according to claim 6, wherein the switch key is disposed on the control board, the switch key is constrained between the control board and the housing.

8. The automatic manual electronic cigarette according to claim 6, wherein the shift key comprises a base and a pushing member, the plugging member is disposed at the upper end of the base, the locking member is disposed at the lower end of the base, the base is located in the housing, an opening is defined in the housing at a position corresponding to the shift key, the pushing member protrudes outside through the opening of the housing.

9. The automatic manual electronic cigarette according to claim 6, wherein the housing and the bottom cover are connected by an interference fit.

10. The automatic manual electronic cigarette according to claim 5, wherein the automatic manual electronic cigarette further comprises a connecting member, the connecting member is located at the upper end of the housing, the mouthpiece is connected to the connecting member, the air flow passage is defined in the connecting member.

11. A automatic manual battery assembly for an electronic cigarette, the electronic cigarette comprises an atomizing assembly, the battery assembly comprising:
a battery configured to supply electrical energy to the atomizing device,
a control board;
a sensor, the sensor is signally connected to the control board, the sensor controls closing or opening of the circuit between the battery and the atomizing assembly by sensing a specific parameter;
a switch key; and
a shift key, the shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.

12. The battery assembly according to claim 11, wherein the switch key is directly disposed on the circuit of the atomizing assembly and the battery.

13. The battery assembly according to claim 12, wherein further includes an air flow passage, the air flow passage is in communication with the mouthpiece, the sensor is configured for sensing a change in pressure within the air flow passage.

14. The battery assembly according to claim 13, wherein the sensor is a pressure sensor, an air passage of the sensor is in communication with the air flow passage, the sensor senses a pressure change in the air flow passage.

15. The battery assembly according to claim 13, wherein the shift key includes a plugging member and a locking member, when the shift key is displaced to the second position, the plugging member is disengaged or partially disengaged from the air flow passage, the locking member is latching the switch key, the control function of the sensor is triggered; when the shift key is displaced to the first position, the plugging member blocks the air flow passage, the locking member is separated from the switch key, the control function of the switch key is triggered.

16. The battery assembly according to claim 15, wherein the automatic manual electronic cigarette further comprises a housing and a bottom cover; the atomizing assembly, the control board and the battery are received in the housing.

17. The battery assembly according to claim 16, wherein the switch key is disposed on the control board, the switch key is constrained between the control board and the housing.

18. The battery assembly according to claim 16, wherein the shift key comprises a base and a pushing member, the plugging member is disposed at the upper end of the base, the locking member is disposed at the lower end of the base, the base is located in the housing, an opening is defined in the housing at a position corresponding to the shift key, the pushing member protrudes outside through the opening of the housing.

19. The battery assembly according to claim 16, wherein the automatic manual electronic cigarette further comprises a connecting member, the connecting member is located at the upper end of the housing, the mouthpiece is connected to the connecting member, the air flow passage is defined in the connecting member.

20. An automatic manual electronic cigarette comprising:
an atomizing assembly; and
a battery assembly, the battery assembly comprises a battery configured to supply electrical energy to the atomizing device, a control board, a sensor, a switch key and a shift key; the sensor is signally connected to the control board, the sensor controls closing or opening of the circuit between the battery and the atomizing assembly by sensing a specific parameter; the shift key is capable of displacing to the first position and the second position, when the switching button is displaced to the first position, the sensor is prevented from sensing the specific parameter, the switch key is capable of mechanically displaced and control closing or opening of the circuit between the battery and the atomizing assembly; when the shift key is displaced to the second position, the switch key cannot mechanically displaced, the sensor is capable of sensing the specific parameter.
